(19) United States
(12) Patent Application Publication
(10) Pub. No.: US 2010/0032347 A1
(43) Pub. Date: Feb. 11, 2010

(54) GAS-PHASE HYDROTREATING OF MIDDLE-DISTILLATES HYDROCARBON FEEDSTOCKS

(75) Inventors: Zbigniew E. RING, Aurora, IL (US); Jinwen CHEN, Edmonton (CA)

Correspondence Address: KIRBY EADES GALE BAKER, BOX 3432, STATION D, OTTAWA, ON, K1P 6N9, CA

(73) Assignees: HER MAJESTY THE QUEEN IN RIGHT OF CANADA AS REPRESENTED; BY THE MINISTER OF NATURAL RESOURCES CANADA, Ottawa (CA)

(21) Appl. No.: 12/538,929

(22) Filed: Aug. 11, 2009

(30) Foreign Application Priority Data
Aug. 11, 2008 (CA) PCT/CA2008/001445

(51) Int. Cl. C10G 45/00; B01J 19/00

(52) U.S. Cl. 208/264; 422/189

(57) ABSTRACT

A method of subjecting a middle-distillate hydrocarbon feedstock to a hydrotreating reactions to remove heteroatoms and/or hydrogenate aromatics, and apparatus therefor. The method comprising heating a liquid middle distillates hydrocarbon feedstock to produce a heated feedstock, mixing the heated feedstock with a hydrogen-containing treating gas to produce a mixture, and bringing the mixture into contact with a hydrotreating catalyst at an elevated temperature and an elevated pressure effective for hydrotreating the feedstock. The hydrogen-containing gas is mixed with the heated feedstock in a ratio effective to fully vaporize the liquid feedstock at the elevated temperature and pressure before the feedstock is contacted with said hydrotreating catalyst. Ideally, the mixture is passed through a catalyst bed creating a pressure drop in the gas mixture equal to or less than 0.3 bar/m. Such a catalyst bed may be made of structured catalysts, such as monolithic catalysts.

### BACKGROUND OF THE INVENTION

(1) Field of the Invention

This invention relates to the refining of middle-distillates of hydrocarbons derived from crude oil or other sources into blending components of diesel fuel. More particularly, the invention relates to the hydrotreating of such distillates for the purpose of reducing the content of organic compounds containing such heteroatoms as sulfur, nitrogen and oxygen (e.g. to reduce diesel fuel contaminants), and/or for the purpose of reducing the content of aromatic hydrocarbons (e.g. to improve the ignition characteristics of diesel fuel).

(2) Description of Related Art

Diesel oil has been an important fuel for internal combustion engines for decades and its use has been steadily increasing because it offers improved mileage in modern engines. Diesel oil is conventionally obtained as a suitable blend of various middle-distillates fractions of hydrocarbons (blending components) derived from a variety of crude materials but predominantly from crude oil. Lighter distillates are conventionally used as other fuels, e.g. gasoline, and heavier distillates yield heavy oils that are typically converted into fuels of lower boiling range through further processing. Middle distillates fractions (like most products derived from crude oil) normally contain undesirable compounds containing heteroatoms such as sulfur, nitrogen, and oxygen, that can cause air pollution and other problems (e.g. deactivation of catalytic converters, corrosion, etc.) when burned. For the most part, the solution to this problem has been to remove heteroatom-containing contaminating compounds by a process referred to as hydrotreating which involves converting sulfur into hydrogen sulfide, nitrogen into ammonia, and oxygen into water. The contaminant-containing products can then be separated from the hydrotreated distillates and disposed of in a non-polluting way. As well as providing purity improvements, hydrotreating may also be used for improving the ignition characteristics of middle-distillates by the hydrogenation of aromatic compounds. According to the Ultra Low Sulphur Diesel standard in Canada and the United States, the content of sulfur in diesel fuel in 2006 was to be less than 15 ppm, while in Europe it was to be less than 10 ppm. Such standards are becoming ever more stringent with each passing year. However, such purity improvements, while possible, are expensive to achieve.

Hydrotreating involves combining a feed of middle distillates hydrocarbons with a hydrogen-rich gas and reacting the mixture over a bed of suitable catalyst at a suitably elevated temperature and pressure. An example of a conventional desulphurization treatment of hydrocarbons is disclosed in U.S. Pat. No. 3,193,495 issued to Ellor et al. on Jul. 6, 1965. Commercially, hydrotreating is typically carried out in trickle-bed reactors. These are mixed-phase (gas and liquid) reactors that utilize co-current flows of the fluids downwardly through a fixed bed of catalyst. Hydrotreating is associated with some degree of hydrogenation. Hydrogenation reactions, being highly exothermic, cause significant ascending axial temperature gradient in the hydrotreater. Therefore, frequently, the catalyst is divided into several beds. The reacting mixture of the gas and liquid phases leaving a preceding bed is cooled in an inter-bed space, by admixing the reacting mixture with a cold treating gas, and then redistributed over the following bed. In order to support the individual beds and evenly distribute the flowing phases over the top of catalytic beds, the hydrotreater reactor contains various devices and internal structures.

The catalyst bed normally consists of small, porous, randomly packed catalyst extrudates. For the hydrotreating of middle distillates, depending on the given quality of the feedstock and desired quality of the product, the reactors may be operated under a wide range of temperatures (e.g. between 300 and 450° C.), pressures (e.g. 20 to 120 bars), space velocities (e.g. 0.2 to 10 L/L/h) and treatment-gas-to-oil ratios (e.g. 100 to 1000 NL/kg). Typically, alumina-based Co/Mo, Ni/Mo or tri-metallic Co/Ni/Mo catalysts are used. However, noble metal or bulk metal catalysts may also be appropriate for some applications. The liquid feedstock and the treatment gas are compressed and heated to a predetermined reactor-inlet temperature before they enter the reactor. Under the operating conditions, the hot liquid partially flashes to vapor and the treatment gas partially dissolves in the remaining liquid. This creates two phases that have significantly different compositions than the original liquid feedstock and treatment gas. At this point, 10 to 60% of the liquid feedstock is typically found in the gas phase. After the flashing, some of the sulfur compounds originally present in the liquid feedstock are mostly found in the gas phase, while others are mostly found in the liquid phase depending on their respective boiling points. The liquid phase tends to move through the reactor more slowly than the gas phase and, unlike the gas phase, it remains in direct contact with the catalyst. Therefore, only the compounds that are present in the liquid phase can readily take part in the hydrotreating reactions, such as hydrodesulphurization (HDS), hydrodenitrogenation (HDN), hydrodeoxidation (HDO) and hydrogenation. The reacting molecules that, under the operating conditions, are found mostly in the gas phase, having been depleted from the liquid phase as a result of flashing, have to first re-dissolve in the liquid phase flowing through the catalyst bed, diffuse to the external surface of the catalyst particle, then into the catalyst particle, and then react on the internal surface of the catalyst. The reaction products then have to diffuse out of the catalyst particle into the flowing liquid and partially into the gas phase. Each of these steps contributes to the overall rate of the hydrotreating reactions. For example, in hydrotreating of middle distillates, the rate of diffusion into the catalyst particle is typically controlling the overall hydrodesulphurization (or other) rate, which results in incomplete catalyst utilization and limited overall conversion. Better catalyst utilization can be achieved by using catalyst particles of a smaller effective size, but this increases the pressure drop across the catalyst bed and results in a need for additional gas compression capacity that significantly increases the capital cost of the installation. The optimum compromise between the catalyst size and the cost of the hydrotreater equipment is usually determined during the hydrotreater design phase, and the resulting design typically leads to incomplete catalyst utilization.

Accordingly, in view of the expected more stringent specifications for contaminants in diesel fuel, there is a need for improvements in the hydrotreating process, at least as it is applied to the refining of middle-distillates hydrocarbons.

### BRIEF SUMMARY OF THE EXEMPLARY EMBODIMENTS

In certain exemplary embodiments, the desired intensification of hydrotreating is achieved by carrying out the hydrotreating reactions entirely in the gas-phase rather than in mixed-phase (gas and liquid) flow conditions. Such gas-phase flow conditions may be achieved by mixing a distillates hydrocarbon feedstock and a hydrogen-rich treating gas in a proportion that causes full vaporization of the distillates at the operating temperature and pressure optimized for the hydrotreating reactor operation. The gaseous mixture of the vaporized distillates and treating gas then flows through a hydrotreater reactor filled with a catalyst that is preferably, although not necessarily, in the form of a monolith or other structured catalyst form. The monolith is preferably prepared in such a way that its entire volume consists of a porous supported or bulk catalytic material. The dimensions of channels in the monolith may be optimized to fit as much catalyst as possible into the available volume of the hydrotreater reactor vessel and preferably to maintain a pressure drop of approximately 0.3 bars/m, which is a typical value for commercial trickle-bed operations, or less (and preferably much less). This may be achieved by maintaining the total open face area of the monolith at a suitable level while maximizing the cell-per-square-inch density at the highest level that is possible to manufacture. Such a design maximizes catalyst utilization. The gas-phase hydrotreating process of such exemplary embodiments is therefore fundamentally different from conventional mixed-phase hydrotreating, and it has been experimentally found to offer significant enhancements to the hydrotreating reactions (such as HDS and HDN).

More specifically, one exemplary embodiment preferably provides a method of refining a middle-distillate hydrocarbon feedstock by hydrotreating the feedstock in a catalyst hydrotreater under gas-phase-only operations. The method comprises heating a liquid middle-distillates hydrocarbon feedstock to produce a heated feedstock, mixing the heated feedstock with a hydrogen-containing treating gas to produce a mixture, and bringing the mixture into contact with a hydrotreating catalyst at an elevated temperature and an elevated pressure effective for hydrotreating the feedstock in the presence of the particular catalyst to form a hydrotreated hydrocarbon product. In this procedure, the hydrogen-containing treating gas is mixed with the heated feedstock in a ratio sufficiently high to fully vaporize the liquid feedstock to make said mixture gaseous at the elevated reaction temperature and pressure before the mixture is brought into contact with the catalyst. In the exemplary embodiments of the method, the middle-distillate hydrocarbon feedstock is employed in isolation from other hydrocarbon products, e.g. lighter distillates and heavier distillates. That is to say, the feedstock consists only of middle-distillates as separated from other hydrocarbons by prior conventional or other distillation methods.

Thus, in this exemplary embodiment, instead of simply increasing the pressure of the reactant mixture to compensate for the pressure drop caused by the use of catalyst particles in smaller and more densely packed form, the ratio of middle-distillates feedstock to treating gas is reduced (gas to liquid ratio increased) sufficiently under existing operating conditions of temperature and pressure to ensure that the middle distillate is evaporated completely to gas or vapor before it contacts the catalyst, thereby increasing the effectiveness of the catalyst in the hydrotreating reactions (because the components of the mixture are all in the gaseous phase and consequently diffuse more rapidly and completely to the active surfaces of the catalyst). The process is made more commercially feasible if the structure of the catalyst is made such that the pressure drop is reduced or minimized compared to the use of densely packed catalyst particles, e.g. by employing a structured catalyst bed of optimized design. Thus, exemplary embodiments achieve desired improvements through improved overall reaction rates and/or better catalyst utilization (without increased pressure drop).

In the exemplary embodiments, the hydrotreating reactions may be described as two-phase reactions, i.e. gaseous reactants over a solid catalyst, as compared to the conventional three-phase reactions (gas, liquid and solid).

According to another exemplary embodiment, there is preferably provided an apparatus for subjecting a middle-distillates hydrocarbon feedstock to hydrotreating reactions. The apparatus comprises a heater for heating a liquid middle-distillate hydrocarbon feedstock to produce a heated feedstock, a source of a hydrogen-containing gas, a flash device (for example a flash drum, i.e. an enclosed vessel of suitable capacity) for flashing the heated feedstock to vapor and for mixing the vapor with the hydrogen-containing treating gas from the source to produce a gaseous mixture, a catalyst bed for receiving the gaseous mixture and subjecting the feedstock to hydrotreating reactions to produce an effluent gas, a separator for separating hydrotreated feedstock from the effluent gas, thereby leaving a recycle gas containing unreacted hydrogen and hydrogenated heteroatoms; a removal device (e.g. a gas scrubber for hydrogen sulfide or ammonia removal) for removing the hydrogenated heteroatoms from the recycle gas; and a recycle gas compressor for compressing the recycle gas and feeding the compressed recycle gas to the flash device. The apparatus includes the necessary conduits or feed lines for interconnecting the elements as required for the hydrotreating reaction, separation of product and recycling of the treating gas with input of fresh hydrogen-containing gas. The apparatus is operable and, in use, is operated to achieve a ratio of the recycle gas and hydrogen to the hydrocarbon feedstock effective to ensure complete vaporization of the feedstock in the flash device.

In the apparatus, the catalyst bed preferably contains a structured catalyst body to minimize the pressure drop as the reaction gas passes through the catalyst bed.

More information about the reactants, catalysts, reaction conditions and apparatus as used herein is provided below.

### BRIEF DESCRIPTION OF THE DRAWINGS

Exemplary embodiments of the invention are described in more detail in the following with reference to the accompanying drawings, in which:

FIG. 1 is a graph showing gas-to-oil ratios required to achieve full vaporization of a hydrocarbon feedstock at two temperatures and various pressures;

FIG. 2 is a representation, in simplified form, of apparatus that may be used according to one form of the exemplary embodiments;

FIG. 3 is a representation in more detail of the hydrodesulfurization unit of the apparatus of FIG. 2;

FIG. 4 is a representation similar to that of FIG. 2 but of an alternative exemplary embodiment of the apparatus;

FIG. 5 is a representation similar to that of FIG. 3, but of the hydrodesulfurization unit used in the apparatus of FIG. 4;

FIG. 6 is a graph showing sulphur conversion at different gas/oil ratios based on the information of Example 1 below (the shaded part represents conventional gas-liquid hydrotreating);

FIG. 7 is a graph showing total nitrogen conversion at different gas/oil ratios under the same conditions as those used for FIG. 6 (again the shaded part represents conventional gas-liquid hydrotreating); and

FIGS. 8 and 9 are graphs similar to FIGS. 6 and 7 but based on the information of Example 2 below.

### DETAILED DESCRIPTION OF THE EXEMPLARY EMBODIMENTS

### Middle Distillates Feedstock

The middle distillates feedstock may be one or a mixture of several refinery streams, of which the approximate initial boiling point (IBP) is in the range of 100 to 200° C. and final boiling point (FBP) is in the range of 350 to 500° C. A lower boiling hydrocarbon fraction, usually referred to as naphtha, is typically processed separately and becomes a blending component of gasoline. A higher boiling hydrocarbon fraction, usually referred to as gas oil, is typically converted to the boiling range of fuels by means of such conversion refinery processes as hydrocracking or fluid catalytic cracking. Normally, there are boiling point overlaps between naphtha and the middle distillates, and between the middle distillates and gas oil. However, if the middle distillates are destined for diesel fuel blending, the content of naphtha in the middle distillates is typically constrained by the flash point specification of the diesel fuel and the content of gas oil is typically constrained by the end-boiling-point specification of the diesel fuel.

The middle distillates feedstocks suitable for use in the exemplary embodiments may be straight run distillates fractions, hydrocracked distillates, thermally cracked distillates, catalytically cracked distillates, distillates from residue hydroconverters and other hydrocarbon streams of suitable boiling range as specified above. So-called “straight run distillates” are obtained by atmospheric distillation of crude oil. So-called “hydrocracked distillates” may be obtained from a residue hydroconverter or a gas oil hydrocracker. So-called “thermally cracked distillates” may be obtained from refinery processes such as delayed coking, fluid coking, visbreaking, or the like. So-called “catalytically cracked distillates” may be obtained from processes such as fluid catalytic cracking, catalytic pyrolysis, or the like. The distillates feedstocks suitable for use with the exemplary embodiments may be derived from various sources, including virgin crudes, ranging from low-sulphur low-aromatics conventional crudes to high-sulphur high-aromatics bitumen, and including distillates derived from other sources such as oil shale, coal liquefaction products, and biomass.

The composition of distillates is typically examined in terms of sulphur, nitrogen and aromatics mass concentrations. Although the oxygen atom concentration in some oil-shale-derived distillates may be as high 5% by weight, oxygen is rarely a concern in the hydrotreating of more conventional distillates because it is present in small concentrations and reacts relatively easily compared to nitrogen and sulphur under typical hydrotreating conditions. The sulphur atom concentration may be as high as 10% by weight in distillates derived from oil shale, and more typically it ranges from approximately 5 ppm to 2% by weight. The nitrogen atom concentration may be as high as 2,000 ppm by weight in bitumen-derived coker distillates, and more typically it ranges from 1 ppm to 900 ppm by weight. The total concentration of aromatics may range from 5 to 80% by weight as determined by a gas-chromatography-mass-spectrometer method.

### Catalyst

The catalyst may be any hydrotreating catalyst suitable for hydrotreating hydrocarbon distillates. Typically, conventional catalysts contain 2 to 30% by weight of Co, Ni, Mo, and W either alone or in combination and are supported on porous alumina. Additives and promoters such as P, B, and F may be used as other components. Other catalysts suitable for use with the exemplary embodiments include the bulk base metal catalysts. Typically, the BET surface area of the distillates hydrotreating catalyst will range from 100 to 450 m²/g and the pore volume will range from 0.30 to 0.90 mL (H₂O) per g.

The most preferred catalyst for the exemplary embodiments has a shape or structure that minimizes the pressure drop in the reactor and, consequently, reduces the required compression capacity of the treat-gas compressor. The structured catalyst body may be in the form, for example, of a porous monolith, corrugated plates, etc., with any shape of channel or pores. Most preferably, the catalyst is a “honeycomb” monolith with a multitude of parallel channels having shapes ranging from triangular to rectangular to circular surrounded by walls formed from porous catalyst that take up the entire thickness of channel walls. The catalyst may also be provided as a porous coating on a non-catalyst mechanical support structure. The catalyst may also be in the form of extrudates of suitable shape including a cylinder, a trilobe or a quadrulobe, or in the form of corrugated plates. The nominal diameter of the catalyst extrudates preferably ranges from 0.5 to 4 mm and the extrudate length preferably ranges from 2 to 20 mm. Spherical catalysts may also be used. If the existing or designed compression capacity of the hydrotreater is sufficient to deal with respective pressure drops, a random-packed single bed or multiple beds of such small extrudates is a preferred arrangement of the hydrotreater reactor. Examples of suitable catalyst supports are disclosed in U.S. Pat. No. 6,716,339 issued to Liu et al. on Apr. 6, 2004 (the disclosure of which is incorporated herein by reference).

A preferred monolithic catalyst may be prepared by forming any suitable hydrotreating catalyst into honeycomb shapes. These monolithic shapes may have an outer diameter suitable to fit the inner diameter of the reactor vessel, or they may be formed into building blocks that, after assembly, form an assembly of shapes having an outer diameter suitable to fit the inner diameter of the reactor vessel. So, the catalyst shapes can either fill the reactor cross section completely as a single shape or as an assembly of shapes. The monolithic shapes may be of a length suitable to form one complete catalyst bed or the catalyst bed may consist of several layers of monolithic shapes or assemblies of shapes.

The term “structured body” or “structured catalyst” as used in this description and the appended claims means a unitary body containing elongated, usually parallel, pores or channels that allow permeation of gases through the body, the inner surfaces of which pores or channels may be coated with a catalyst.

The term “monolithic body” or “monolithic structure” means a single block of material capable of forming a complete catalyst bed or a substantial part thereof, having interconnected pores or channels that allow permeation of gases through the body, the inner surfaces of which pores or channels may be coated with a catalyst. Preferably, the pores or channels are such that laminar flow of the mixed gases may take place through the pores or channels in the body.

A “monolithic catalyst” is a catalyst structure formed by coating the internal surfaces of a monolithic body or structure with a catalyst.

### Reactor

During conventional hydrotreating, the feedstock and treating gas are contacted with the catalyst in a hydrotreating reactor, which typically consists of a vertical high-pressure vessel with an internal structure suitable for liquid distribution, catalyst bed support trays and temperature measurement devices. The catalyst may be arranged as single or multiple catalyst beds separated by quench zones. Each catalyst bed preferably has a liquid distribution structure located over the top and the catalyst in each bed is supported by a tray. Typically, the reacting mixture of the gas and liquid phases flows downward through the catalyst bed. The flow of the discontinuous liquid phase relies on the gravitational force and interactions with the flowing continuous gas phase. The flow of the continuous gas phase relies on the positive pressure differential between the inlet and the outlet of the hydrotreater. The reacting mixture leaving each catalyst bed, mixes up with the cooling treat gas in the quench zone. Subsequently, the liquid phase is distributed evenly over the top of the catalyst bed below the quench zone by the liquid distribution structure and then the mixture enters the next catalyst bed. The metallurgy of the hydrotreater reactor vessel and its wall thickness are suitable for the walls to withstand operation at elevated temperatures and pressures specific to a particular hydrotreating application.

The exemplary embodiments preferably use a hydrotreater which consists of a vertical reactor vessel similar to the conventional hydrotreater for a similar application. The reactor is operated in the gas-flow mode and only a gas phase flows through the catalyst. The gas may flow upwards to facilitate the separation of any potential residual liquid that gathers at the bottom of the vessel, which can be removed from there at a suitable rate. The catalyst may be arranged as a single or multiple catalyst beds separated by quench zones. When multiple beds are used, the catalyst in each bed is preferably supported by a tray. In the most preferred embodiment, the catalyst used is in the form of monolithic shapes.

### Operating Conditions

The operating conditions of most importance in hydrotreating include: average temperature, average pressure, liquid hourly space velocity, and treating-gas-to-oil ratio. The average temperature in the hydrotreater is varied in the range from a minimum determined by the onset of the catalytic activity of interest and a maximum determined by the reactor metallurgy, wall thickness and operating pressure. The temperature range may be, for example, from 250 to 450° C., preferably from 300 to 400° C., and most preferably from 320 to 380° C. In this range, the average temperature in the reactor depends on the desired specification of the product and the length of the catalyst life cycle. The operating temperature may also be constrained by hydrogen consumption, selectivity of the key hydrotreating reactions, peak temperature in any of the beds, energy requirements, and the like. Typically, only the temperature of the feedstock at the reactor inlet and the temperatures in quench zones can be adjusted to reach the desired average temperature. Temperatures in individual catalyst beds increase as a result of the process due to the progress of the highly exothermic hydrogenation reactions. In addition, the average temperature in the reactor may be increased over the catalyst life cycle to offset the typically observed losses of catalyst activity.

The operating pressure may be varied in the range from a minimum determined by the desired extent of the hydrotreating reactions of interest, and a maximum determined by reactor metallurgy, reactor wall thickness, peak temperature in the reactor and the pressure drop. The operating pressure may vary between 20 and 200 bars, and more preferably between 40 and 80 bars. In addition the pressure drop may be increasing during the catalyst life cycle due to catalyst fouling.

The hourly liquid space velocity is the ratio of hydrocarbon feedstock volumetric flow rate estimated at ambient conditions to the amount of catalyst frequently expressed in litres of feedstock per litres of catalyst per hour. Typically, space velocity is fixed by the requirement for a constant throughput of the refinery and it may vary between 0.2 and 10 L/L/hr, and more preferably between 0.5 to 6 L/L/hr.

It will be noted that the distillate feedstock, pumped through the reactor at a rate corresponding to the operating space velocity, is substantially fully vaporized under the operating pressure and in the range of operating temperatures used in the hydrotreater. The current exemplary embodiments may call for hydrotreater operation at temperatures, pressures and space velocities typical for mixed-phase trickle-bed operation but with full evaporation that may be achieved by applying sufficiently high treating-gas-to-oil ratios.

In order to achieve complete vaporization of the feedstock, the hydrogen-containing gas is mixed with the liquid feedstock in a suitably high ratio. Depending on the feedstock and operational conditions, the treating-gas-to-oil ratios are generally more than 1000 Normal Liters per kilogram (NL/kg), usually more than 1500 NL/kg, often more than 2500 NL/kg and frequently more than 4000 NL/kg. Preferred ranges are generally 1000 to 8000 NL/kg, 1500 to 8000 NL/kg, 2500 to 8000 NL/kg, and 4000 to 8000 NL/kg. In conventional mixed-phase trickle-bed operations, the gas/oil ratio is normally constrained by the maximum pressure drop that can be accommodated by the compressor used for gas recirculation and is usually less than 1000 NL/kg and often in the range of 300 to 800 NL/kg. Higher gas/oil ratios can be provided either by utilizing one or more compressors of increased pressure drop capability, or by minimizing the pressure drop through the reactor (particularly by minimizing the pressure drop through the catalyst bed). There is an economic limit to improving the pressure-drop capability of the compressors, so high treating-gas-to-oil ratios are better enabled by reducing the pressure drop within the reactor. It has been found that, if the middle distillates feedstock is completely vaporized and mixed with a hydrogen-containing treating gas before it enters the reactor containing the catalyst bed, the pressure drop is reduced and the hydrotreating reactions may be carried out at a greater rate than when reacting mixed gas and liquid phases. This is because all of the components of the reacting mixture have access to the catalyst surface throughout the process with a faster diffusion rate. It is generally not preferable to achieve complete vaporization of the feedstock simply by increasing the reactor inlet temperature (because of the high energy requirements to vaporize the feedstock) nor by simply lowering the pressure in the reactor (because high hydrogen partial pressures are needed to carry out the hydrotreating reactions effectively). Instead, in the exemplary embodiments, the treatment-gas-to-oil ratios ratio employed for the reactions are significantly increased over those used for conventional reactions. For example, conventional processes may use a treating-gas-to-oil ratio of 300:1 to as much as 1000:1 (NL/kg), but generally operate at about 500:1 NL/kg or less and achieve only partial vaporization (typically 10 to 60%) of the feedstock. In contrast, the exemplary embodiments (operated at the same temperatures and pressures) may require ratios between 1000 to 8000:1 NL/kg to achieve full vaporization of the feedstock. The use of such high treating gas ratios increases the efficiency of the hydrodesulfurization (or other) reactions due to the increased diffusion rate in the gas phase and, therefore, increases the overall reaction rate. Such high gas recirculation rates can be achieved by providing additional gas delivering capacity. For structured catalyst beds, and particularly for monolithic catalysts, which are preferred, the pressure drop generated by the catalyst bed (or beds) remains low due to fact that the reactants flowing through the catalyst bed are completely gaseous and in a laminar flow mode.

### Flashing Liquid to Vapor

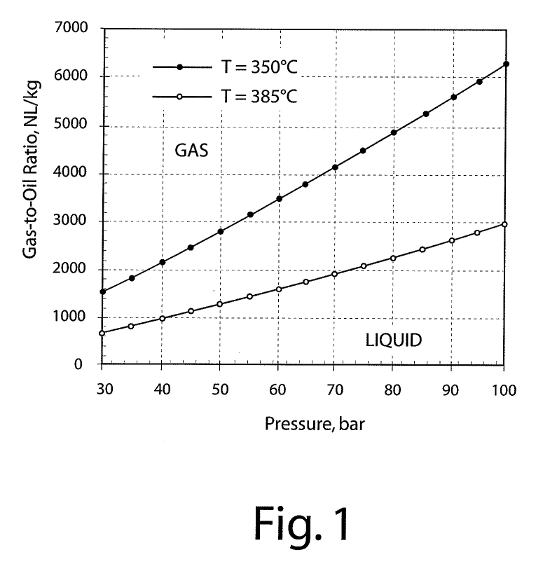

As pointed out above, one of the compositional characteristics of middle distillates is their boiling point distribution. Those skilled in the art appreciate that the treating-gas-to-oil ratio required to vaporize a hydrocarbon fraction of distributed boiling point at a given temperature and pressure can be found experimentally or calculated using a vapour-liquid-equilibrium software. This kind of software is available in commercial software packages such as HySys® by AspenTech of 200 Wheeler Road, Burlington, Mass. 01803, U.S.A. The type of information generated by vapour-liquid equilibrium software is illustrated in FIG. 1 of the accompanying drawings. On a phase map of treating-gas-oil ratios versus pressure, this figure shows the borders between the gas and liquid regions at two different temperatures, 350° C. and 385° C. This map demonstrates that at a certain temperature, in the range of treating-gas-to-oil ratios and pressures shown, for any pressure there is a treating-gas-to-oil ratio that completely volatilizes the light cycle oil feedstock.

In operation of the invention, the correct gas-to-oil ratio to achieve full flashing to vapour can be determined by utilizing a flash calculation program, e.g. of the kind mentioned above, for a particular liquid feedstock flow rate (normally established by the production capacity of the apparatus). The total gas flow rate can be calculated, which includes fresh hydrogen and recycled hydrogen, and the apparatus can be designed or controlled to provide such a flow rate. In practice, both the liquid feed and the total gas flow rates may be metered to ensure that the desired gas-to-oil ratio is achieved.

### Pressure Drop

With the use of high treating-gas-to-oil ratios to achieve gas phase operation under the similar liquid hourly space velocity as that used in a conventional trickle-bed hydrotreater, the total gas throughput in the hydrotreater is much higher than that in the conventional apparatus. Such a high gas throughput may cause a significant increase in pressure drop across the hydrotreater, resulting in the need of gas compressors of higher pressure head. Under certain conditions and/or with particular commercial operation constraints, such a need may not be met or may be impractical to meet. In such cases, the use of a monolith reactor will solve the problem. The most outstanding advantage of monolith reactors is their low pressure drop, especially under high fluid throughput. Calculations made by the inventors have shown that compared to conventional particle-packed reactors operating under similar conditions, monolithic reactors have at least two orders of magnitude lower pressure drop. For example, at gas velocity of 2 m/s, the pressure drop in a monolith hydrotreater is 0.002 bar/m while it is 0.22 bar/m in a conventional particle-packed hydrotreater. Therefore, the pressure drop is not a concern for the commercial application of monolithic reactors for the exemplary embodiments of the gas phase hydrotreating reactions.

### Catalyst Utilization and Effective Catalyst Size

Those skilled in the art will appreciate that hydrotreating catalysts, as used conventionally, are not fully utilized because of the interplay between the intrinsic rate of the surface reactions of interest and diffusion limitations in the pores of the catalyst body. The text-book measure of catalyst utilization, the catalyst effectiveness factor, is defined as the ratio of the effective reaction rate in a catalyst body and the intrinsic rate of the reaction of interest, and it is the function of the intrinsic reaction rate constant, effective diffusivity in the catalyst pores, and catalyst body shape and size. The catalyst effectiveness factor can be interpreted as the fraction of the catalyst volume that effectively catalyzes the specific reaction. The size of the catalyst body actually used commercially is a trade-off between the maximum achievable catalyst utilization and the acceptable pressure drop. Smaller body sizes favour catalyst utilization, but result in undesired larger pressure drops. For example, the effectiveness factor of modern hydrodesulphurization catalysts operated at typical commercial conditions may be as low as 0.5. This could be interpreted that as little as 50% of the catalyst effectively catalyzes the desired reactions.

Those skilled in the art will also appreciate that, under the typical operating conditions in the hydrotreater, there are interactions among the various hydrotreating reactions. For example, higher concentrations of nitrogen and aromatic compounds in the feedstock tend to suppress the rate of hydrodesulphurization. These interactions may also have impact on the catalyst utilization.

### Operational Embodiments

In exemplary embodiments, the catalyst is held within a suitable reactor which may include one or several monolithic catalyst beds arranged in series, wherein each catalyst bed has an inlet end and an outlet end and a direction of flow from the inlet end to the outlet end. Preferably, the direction of flow is substantially parallel to the axial alignment of the channels of the catalyst bed.

The reaction mixture is formed by mixing the liquid feedstock with a treating gas in a proportion sufficient to fully volatilize the liquid at the operating temperature and pressure maintained in the reactor. The reaction mixture may flow up or down through the volatilization reactor. Most preferably it flows up to allow, if necessary, for the separation of any potential condensed liquid before the mixture enters the inlet of the reactor bed. The condensate may be collected at the bottom of the volatilization reactor and removed.

As noted above, the exemplary embodiments involve passing a fully gaseous mixture of hydrogen or a hydrogen-containing gas and a middle-distillate hydrocarbon fraction through a catalyst bed. The catalyst component may, for example, include a powdered refractory oxide and transition metal catalyst compounds deposited on a support, e.g. inert refractory particles or small extrudates, e.g. spheres, cylinders, trilobes or quadrulobes, etc. More preferably, the catalyst is supported within a structured catalyst support, e.g. on the inner surfaces of a monolithic catalyst support. Alternatively, the catalyst components may be incorporated into the catalyst support itself, e.g. within the monolithic honeycomb catalyst support.

The catalyst is held within a suitable reactor which may include one or several monolithic catalyst beds arranged in series, wherein each catalyst bed has an inlet end and an outlet end and a direction of flow from the inlet end to the outlet end. Preferably, the direction of flow is substantially parallel to the axial alignment of the channels of the monolithic catalyst bed. Those of ordinary skill in the art will appreciate that many other conventional components useful for the operation of the apparatus may also be employed. Such components will include a suitably sized reaction containment vessel, pumps, valves, pipes and control means for feeding the reactor and removing the desired product; and temperature, pressure and safety and reaction monitoring controls and electronics used to control and operate the reactor safely. Such additional equipment and apparatus will be apparent to those of ordinary skill in the art of reactor design and chemical engineering.

When a monolithic support is employed, the density of cells within the monolithic support is generally measured in cells per square inch of surface area. The cell density may be varied throughout a wide range typically from about 25 to about 1600 cells per square inch (cpsi). For a given volume of the catalyst, the greater the cell density, the thinner will be the cell walls and the greater will be the catalyst utilization. In one preferred embodiment the walls of the monolithic honeycomb refractory supports are made of alumina or aluminasilicate and have an average pore size from 2 μm to 1000 μm with BET surface areas in the range of about 10 to about 400 m²/g. Where a wall material of alumina is used as a substrate for an applied catalyst, gamma-alumina honeycomb substrates are preferred.

Alternatively monolithic honeycomb refractory support formed of other durable materials such as cordierite (a magnesium aluminosilicate) can be provided with a coating of alumina. Alternatively, the cordierite monolithic honeycomb refractory supports can be wash-coated with impregnated particulate catalyst in a manner that one of skill in the art should know and understand. U.S. Pat. No. 4,771,029 describes one such method of “washcoating” a honeycomb catalyst support with a catalyst component. The contents of U.S. Pat. No. 4,771,029 are hereby incorporated in their entirety by reference. In the patent, a monolith is washcoated with catalyst particles to treat automotive exhaust gases, however, the same or similar methods of washcoating can be used to washcoat catalyst particles onto monolithic honeycomb refractory supports of the present invention. In such instances, the monolithic honeycomb refractory support serves as a relatively inert carrier for the particulate catalyst. Alternatively, the monolithic honeycomb refractory support itself can be the active catalyst impregnated with the hydrotreating catalyst and inert particles can be washcoated onto the monolithic honeycomb refractory support. Yet another alternative embodiment is to first washcoat the monolithic honeycomb refractory support with alumina or alumina-silica particles and then to impregnate the washcoated monolithic honeycomb refractory support. Regardless of the method used to achieve the final monolithic honeycomb catalyst bed or the blocks of monolith that make up the final monolithic honeycomb catalyst bed, the catalytic activity of the hydrotreating catalyst can be carefully controlled and adjusted systematically to optimize the catalyst formulation.

In one illustrative and preferred embodiment, the catalytic components of the monolithic honeycomb catalyst bed are impregnated into the monolithic honeycomb refractory support by any suitable conventional means. For example, an impregnating solution containing Group VIB and VIII metal salts that decompose upon heating is formulated and then the monolithic honeycomb refractory support is immersed in the impregnating solution. Other methods known to one of ordinary skill in the art may also be used, such as ion exchange methods for incorporating the precursor materials into the monolith, and so forth.

Another illustrative and preferred embodiment utilizes a suitable catalyst support in powder form that has been impregnated with a solution containing Group VIB and VIII metal salts that decompose upon heating for an appropriate time period. The impregnated powder is then washcoated onto the surface of the monolithic honeycomb refractory support as previously noted above.

Suitable impregnation solutions include aqueous solutions containing Group VIB and VIII transition metal salts that decompose upon heating. For example suitable salts include cobalt nitrate, ammonium molybdate, nickel nitrate and ammonium metatungstate. Thus, conventional hydrodesulfurization catalysts such as, Co, Ni, Mo, and W, alone or in combination with other catalyst additives and promoters such as phosphorus can be used. Conventional catalyst loadings may be used with metal catalyst concentrations, measured as the final metal oxide content, in the range of 2 to 30 weight percent based on weight. Variations of concentration, particle size, porosity, surface area, the presence or absence of promoter elements, and so forth may be made systematically to achieve the optimum conditions for impregnation.

Once the monolithic honeycomb refractory support has been either impregnated itself or washcoated, the monolith is heated or calcined to decompose the metal salts present to form metal oxide compounds that serve as stable precursors of the final catalyst. Calcination is generally carried out in air at a temperature from about 120° C. to about 650° C. and preferably from about 200 to 500° C.

Prior to use in the processes of the present invention, the monolithic honeycomb catalyst bed may need to be activated or otherwise treated in situ before achieving full activity. In the case of hydrodesulfurization monolithic honeycomb catalyst bed the monolithic honeycomb catalyst bed must be sulfided to form the fully active catalyst. Such pre-activation steps and processes are well known in the art for a wide variety of hydrotreating catalysts.

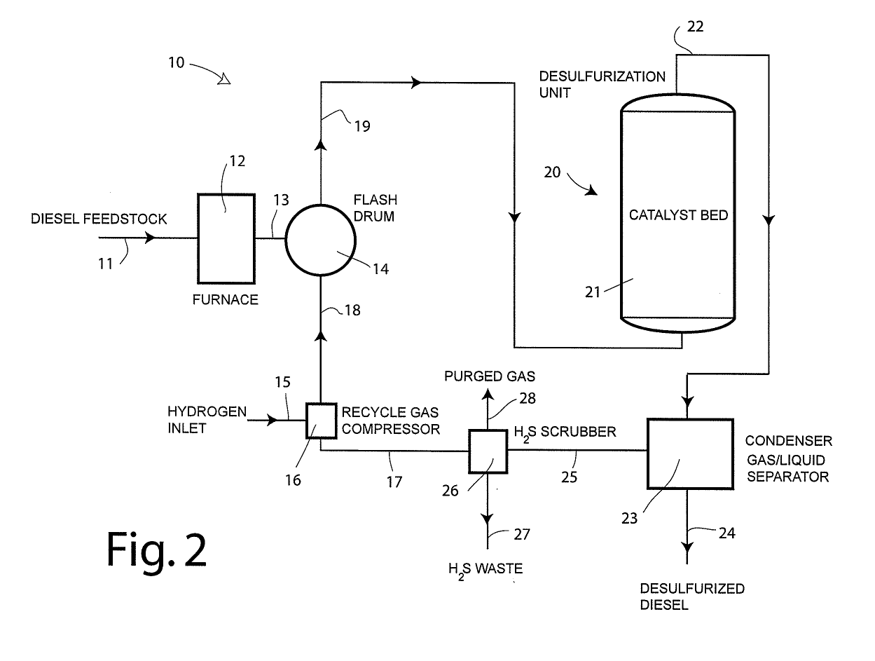

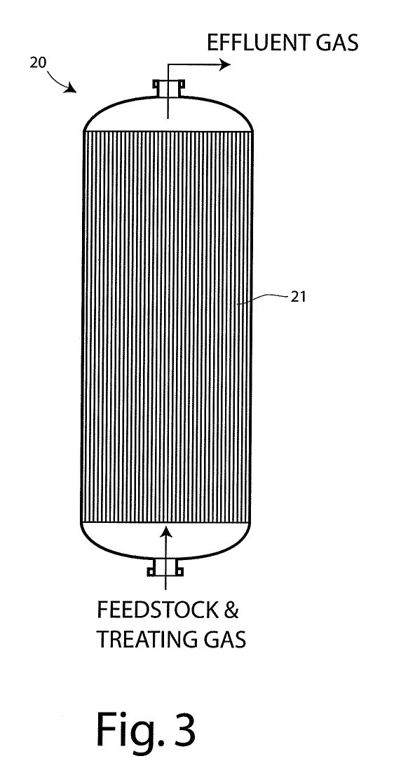

FIGS. 2 and 3 of the accompanying drawings show a simplified representation of apparatus 10 that may be used according to one form of the present invention. As shown in FIG. 2, diesel feedstock (middle distillates fraction hydrocarbon) is introduced via a line 11 into a furnace (heat exchanger) 12 where it is heated to an elevated temperature, normally in the range of 300 to 400° C., more preferably 320 to 380° C., and generally around 350° C. The higher the temperature, the higher the rate of evaporation, but the maximum acceptable temperature is dictated by the temperature-sensitivity of the catalyst and the desire to avoid thermal cracking and coking of the feedstock, so temperatures more than 25° C. higher than the above preferred ranges should normally be avoided. The heated feedstock is then transferred through line 13 to a flash reactor or “flash drum” 14 at a rate commensurate with the desired gas/oil ratio at which the apparatus will operate. Simultaneously, hydrogen gas (or a gas containing a high proportion of hydrogen and a non-reactive remainder) is introduced through line 15 as one feed for a recycle gas compressor 16. Another feed for the compressor 16 is recycle gas, i.e. gas recycled from within the system (as explained later) introduced through line 17. The hydrogen and recycle gas are raised in pressure by the compressor 16 to form a compressed gas, usually having a pressure in the range of 5 to 150 bars, and more usually 40 to 80 bars.

The compressed gas is then introduced into the flash drum 14 via line 18. In this arrangement, it may be necessary to provide flash drum 14 with a heater of some kind (e.g. an electrical coil) to prevent the compressed gas introduced via line 18 from chilling the contents of the drum. Alternatively, the compressed gas, or the hydrogen feedstock, may be heated (e.g. by being passed through a heat exchanger) to raise the temperature to a level similar to that of the diesel feedstock introduced into the drum via line 13.

In the drum 14, the heated diesel feedstock flashes rapidly and completely into vapor after mixing with the compressed gas from line 18 and these components form a mixed gas containing feedstock vapor and hydrogen gas. The mixed gas then passes through line 19 to the bottom of a hydrotreating (e.g. desulfurization) unit 20 that contains a catalyst bed 21, as shown more clearly in FIG. 3. The mixed gas passes upwardly through the bed and the catalyst enables the hydrotreating reactions to proceed so that, for example, sulfur compounds contained in the mixed gas are hydrogenated and converted to hydrocarbons and H₂S gas. The catalyst may also be chosen to promote the conversion of compounds containing other heteroatoms to hydrocarbons and gaseous products, e.g. nitrogen-containing compounds to hydrocarbons and ammonia. The effluent gas from the hydrotreating unit 20 exits through line 22 and is transferred to a condenser unit 23 which also acts as a gas/liquid separator. The hydrocarbon vapor condenses and is removed through line 24 as desulfurized diesel (and optionally diesel decontaminated with other heteroatoms). The gaseous component (which contains unreacted hydrogen, H₂S, possibly ammonia and other uncondensed products), exits the condenser 23 via line 25 and is fed to a H₂S scrubber 26 which removes the H₂S as a waste product that exits the scrubber at 27. If the gas contains ammonia, the gaseous component may also be fed to an ammonia scrubber (not shown) for the removal of ammonia. At this stage, some of the gas is normally purged via line 28 to compensate for the later addition of hydrogen and to avoid the build-up of impurities to unacceptable levels. The remaining gaseous component then becomes the recycle gas fed to the compressor 16 via line 17, and the cycle is repeated. The apparatus may therefore be operated continuously for as long as desired or until the catalyst becomes partially or fully inactive.

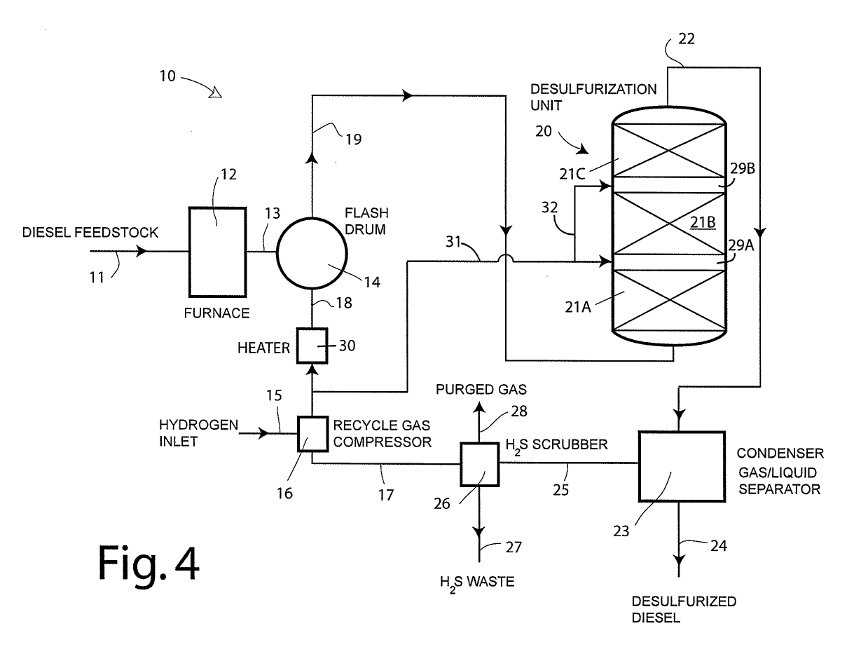

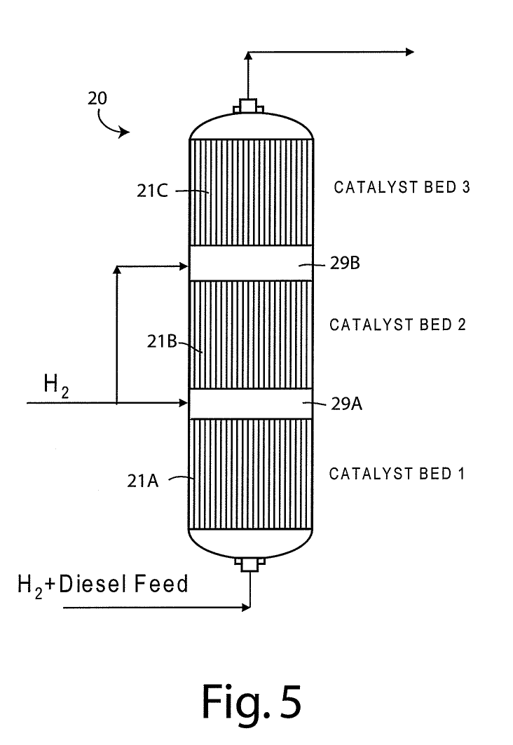

FIGS. 4 and 5 are equivalent to FIGS. 2 and 3, respectively, but show an alternative embodiment in which hydrotreating unit 20 has three separate catalyst beds 21A, 21B and 21C, separated by quench zones 29A and 29B. Some of the compressed gas from compressor 16 is diverted through lines 31 and 32 to the quench zones 29A and 29B to cool the products emerging from the lower and central catalyst beds 21A and 21B to prevent overheating due to the exothermic nature of the reactions taking place. This gas is fairly cool because it is diverted from line 18 before the remainder of the compressed gas passes through a heat exchanger 30 used to raise the temperature of the compressed gas to approximately that of the diesel feedstock introduced into the flash drum 14 via line 13.

In both of these embodiments, sufficient hydrogen or hydrogen-containing gas is introduced via line 15 to ensure a complete vaporization of the diesel feedstock in the flash drum 14. As noted above, the ratio of hydrogen gas to liquid feedstock is much higher than used in conventional apparatus and may be in the range of between 1000 to 8000 NL/Kg. Such a large ratio may be accommodated only if the back pressure developed by the catalyst bed(s) 21 (21A, 21B, 21C) is sufficiently low that the gas can be circulated at a suitably high rate.

It has been found that, because the reactants flowing through the catalyst bed are entirely in the form of gas or vapor, the resistance to material flow provided by the bed is much lower than if one of the components were partially liquid. However, as indicated above, if the back pressure developed by the bed is still too high for efficient operation when using a conventional packed particle catalyst bed, a catalyst supported on a structured body may be used instead.

The invention will be illustrated in more detail with reference to the following Examples that are provided for the purpose of exemplification only and should not be regarded as limiting.

### Example 1

The experiments in this Example were conducted in a pilot plant (pilot plant PP19 of the National Centre for Upgrading Technology (NCUT), Alberta, Canada). The feed used was light cycle oil (from Petro-Can's Edmonton Refinery in Alberta, Canada) which had a density of 0.9338, total sulphur content of 1.12 wt % and total nitrogen content of 702 wppm. The catalyst used was a commercial NiMo/Al₂O₃ hydrotreating catalyst and 30 ml of the catalyst was packed in the reactor with a 1:1 volumetric ratio dilution of 0.2 mm glass beads. The main feed properties are listed in Table 1 below.

TABLE 1
Properties of Petro-Can LCO

| | |
|---|---|
| Density (15° C.), g/ml | 0.9336 |
| Carbon, wt % | 88.24 |
| Hydrogen, wt % | 10.49 |
| Total sulphur, wppm | 11178 |
| Total nitrogen, wppm | 702.3 |
| SimDis (Simulated | |
| Distillation), ° C. | |
| IBP (Initial Boiling Point) | 126.4 |
| 10 wt % | 225.9 |
| 30 wt % | 256.5 |
| 50 wt % | 288.6 |
| 70 wt % | 327.3 |
| 90 wt % | 375.1 |
| FBP (Final Boiling Point) | 439.9 |

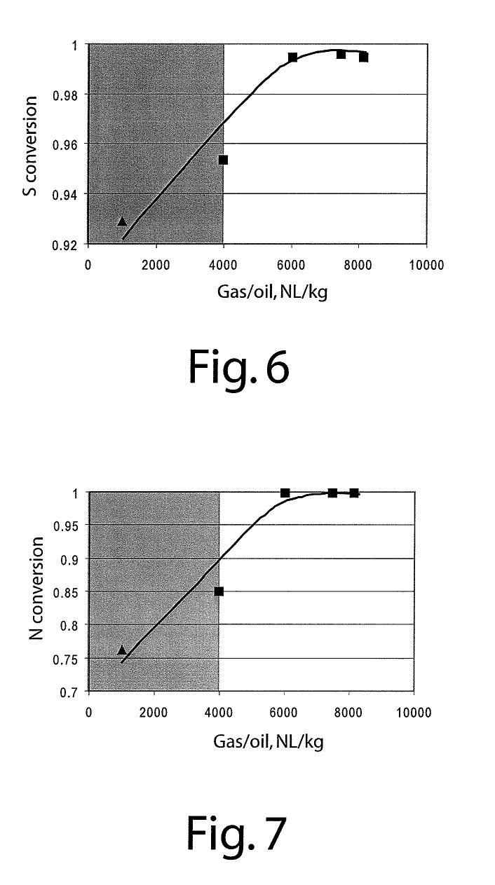

The main objective of this Example was to prove the concept of the gas phase hydrotreating operation. In total, 4 runs were performed at a temperature of 350° C., a pressure of 70 bars, and gas-to-oil ratios of 3958, 6016, 7451, and 8113 NL/kg feed, respectively. The liquid hourly space velocity (LHSV) was maintained at 1.6 L/h. Under these conditions, the hydrotreater was operated in the gas phase according to flash calculations performed using the flash program developed at NCUT. The operating conditions, sulphur and nitrogen contents in the product and conversions are shown in Table 2. The sulphur conversions at different gas/oil ratios are shown in FIG. 6 and the nitrogen conversions at different gas/oil ratios are shown in FIG. 7. A similar trend is observable in both cases. For comparison, a data point obtained in a previous program under similar temperature and pressure, using a similar feed and catalyst but with gas/oil ratio of 1000 NL/kg is also plotted in the figures (the point represented by a solid triangle). The S and N conversion increased significantly when the gas/oil ratio increases from 1000 NL/kg to 3958 and 6016 NL/kg. After that, the sulphur and nitrogen conversions tended to reach a plateau with further increase in gas/oil ratio. The implication of FIG. 6 is that, under the same temperature and pressure, gas phase operation can achieve a higher sulphur conversion than conventional gas-liquid phase operation.

TABLE 2
Hydrotreating of a commercial light cycle oil feedstock

| | | | | | Mixed |
|---|---|---|---|---|---|
| | | | | | phase |
| Hydrotreating system/ | Gas phase operation | | | | operation |
| conditions | Run 1 | Run 2 | Run 3 | Run 4 | Run 5 |
| Temperature, ° C. | 350 | 350 | 350 | 350 | 350 |
| Pressure, bar | 70 | 70 | 70 | 70 | 70 |
| Space velocity, 1/h | 1.6 | 1.6 | 1.6 | 1.6 | 1.56 |
| Gas-to-oil ratio, NL/kg | 7451 | 8113 | 6016 | 3958 | 1000 |
| Sulphur content in feedstock, wppm | 11178 | 11178 | 11178 | 11178 | 11553 |
| Sulphur content in product, wppm | 48 | 51 | 53 | 517 | 817 |
| Sulphur conversion, % | 99.6 | 99.5 | 99.5 | 95.4 | 92.9 |
| Nitrogen content in feedstock, wppm | 702 | 702 | 702 | 702 | 878.4 |
| Nitrogen content in product, wppm | 1.57 | 1.25 | 1.60 | 105.27 | 209.75 |
| Nitrogen conversion, % | 99.8 | 99.8 | 99.8 | 85.0 | 76.1 |

### Example 2

The experiments in this Example were also conducted in a pilot plant (NCUT's PP12). The feed used was light cycle oil (from Irving Oil), which had a density of 0.9708, total sulphur of 1.24 wt % and total nitrogen of 611 wppm. The catalyst used was a commercial NiMo/Al₂O₃ hydrotreating catalyst; 100 ml of catalyst was packed in the reactor with 1:1 volumetric ratio dilution of 0.2 mm glass beads. The main feed properties are listed in Table 3 below. The operating conditions were: temperature=380° C., pressure=70 bars, and LHSV velocity=1.0/h. The gas/oil ratios ranged from 403 to 5054 NL/kg.

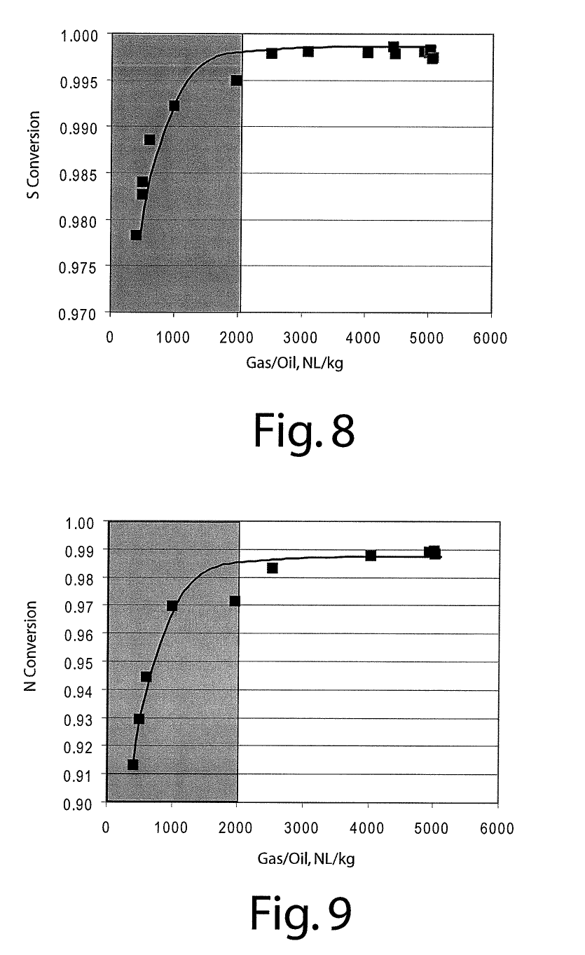

The sulphur and nitrogen conversion data are shown in Table 4 below and the corresponding plots are showing in FIGS. 8 and 9, respectively. It is observed that the sulphur and nitrogen conversion increases significantly when the gas/oil ratio increases from 403 NL/kg to 2522 NL/kg. After that, the sulphur conversion tended to reach a plateau with further increase in gas/oil ratio. The implication of these figures is that under the same temperature and pressure, gas phase operation can achieve much higher sulphur and nitrogen conversion than conventional gas-liquid phase operation.

TABLE 3
Properties of Irving LCO

| | |
|---|---|
| Density (15° C.), g/ml | 0.9708 |
| Carbon, wt % | 89.30 |
| Hydrogen, wt % | 9.40 |
| Total sulphur, wppm | 12404 |
| Total nitrogen, wppm | 611 |
| SimDis (Simulated | |
| Distillation), ° C. | |
| IBP (Initial Boiling Point) | 143 |
| 10 wt % | 221 |
| 30 wt % | 253.8 |
| 50 wt % | 284.6 |
| 70 wt % | 323.8 |
| 90 wt % | 372 |
| FBP (Final Boiling Point) | 563.4 |

TABLE 4
Hydrotreating of an Irving light cycle oil

| | | Gas-to- | Sulphur in | Sulphur in | | Nitrogen in | Nitrogen | |
|---|---|---|---|---|---|---|---|---|
| | | oil ratio | feedstock | product | Sulphur | feedstock | in product | Nitrogen |
| | Run# | NL/kg | wppm | wppm | conversion % | wppm | wppm | conversion % |
| Gas phase | Run 1 | 4456 | 12404 | 26 | 99.79 | 611 | | |
| operation | Run 2 | 4420 | 12404 | 17 | 99.86 | 611 | | |
| | Run 3 | 4921 | 12404 | 24 | 99.81 | 611 | 6.6 | 98.92 |
| | Run 4 | 4992 | 12404 | 25 | 99.80 | 611 | 6.4 | 98.95 |
| | Run 5 | 5014 | 12404 | 21 | 99.83 | 611 | 7.0 | 98.85 |
| | Run 6 | 4022 | 12404 | 25 | 99.80 | 611 | 7.4 | 98.79 |
| | Run 7 | 3081 | 12404 | 24 | 99.81 | 611 | | |
| | Run 8 | 2522 | 12404 | 26 | 99.79 | 611 | 10.2 | 98.33 |
| | Run 9 | 5054 | 12404 | 31 | 99.75 | 611 | | |
| | Run 10 | 5045 | 12404 | 33 | 99.74 | 611 | | |
| | Run 11 | 1954 | 12404 | 63 | 99.49 | 611 | 18.5 | 96.97 |
| Mixed | Run 12 | 606 | 12404 | 142 | 98.85 | 611 | 34 | 94.44 |
| phase | Run 13 | 491 | 12404 | 214 | 98.27 | 611 | | |
| operation | Run 14 | 497 | 12404 | 198 | 98.41 | 611 | 43 | 92.96 |
| | Run 15 | 403 | 12404 | 269 | 97.83 | 611 | 53 | 91.33 |
| | Run 16 | 992 | 12404 | 96 | 0.9922 | 611 | 17.4 | 97.16 |

What we claim is:

1. A method of subjecting a middle-distillates hydrocarbon feedstock to hydrotreating reactions, said method comprising:
heating a liquid middle-distillate hydrocarbon feedstock to produce a heated feedstock;
mixing the heated feedstock with a hydrogen-containing treating gas to produce a mixture; and
bringing the mixture into contact with a hydrotreating catalyst at an elevated temperature and an elevated pressure effective for hydrotreating said feedstock to form a hydrotreated hydrocarbon product;
wherein said hydrogen-containing gas is mixed with the heated feedstock in a ratio effective to fully vaporize the liquid feedstock to make said mixture gaseous at said elevated reaction temperature and pressure before said mixture is contacted with said hydrotreating catalyst.

2. The method of claim 1, wherein said hydrocarbon feedstock comprises compounds containing heteroatoms as contaminants that are hydrogenated during said hydrotreating reactions to produce hydrogenated heteroatoms, and said hydrogenated heteroatoms are separated from said hydrotreated hydrocarbon product to produce a refined product.

3. The method of claim 2, wherein said hydrogenated heteroatoms are removed by lowering the temperature of the hydrotreated hydrocarbon product to form a liquid hydrotreated hydrocarbon product and a gaseous component containing said hydrogenated heteroatoms, and separating the liquid hydrotreated product from the gaseous component.

4. The method of claim 1, wherein the gaseous mixture is passed through a catalyst bed having a structure that creates a pressure drop equal to or less than 0.3 bar/m in said gaseous mixture.

5. The method of claim 1, which comprises passing the gaseous mixture through a structured catalyst.

6. The method of claim 1, which comprises passing the gaseous mixture through a monolithic catalyst support containing said catalyst.

7. The method of claim 1, wherein the hydrogen-containing treating gas is mixed with said heated feedstock in an amount ranging from 1000 to 8000 NL/kg.

8. The method of claim 1, carried out on a feedstock comprising middle distillates having initial boiling point (IBP) in the range of 100 to 200° C. and final boiling point (FBP) in the range of 350 to 500° C.

9. The method of claim 1, wherein the mixture is contacted with the catalyst at a temperature in the range of 250 to 450° C.

10. The method of claim 1, wherein the mixture is contacted with the catalyst under a pressure of 20 to 200 bars.

11. Apparatus for subjecting a middle-distillates hydrocarbon feedstock to hydrotreating reactions, said apparatus comprising:
a heater for heating a liquid middle-distillate hydrocarbon feedstock to produce a heated feedstock;
a source of a hydrogen-containing gas;
a flash device for flashing said heated feedstock to vapor and for mixing said vapor with said hydrogen-containing treating gas from said source to produce a gaseous mixture;
a catalyst bed for receiving said gaseous mixture and subjecting said feedstock to hydrotreating reactions to produce an effluent gas;
a separator for separating hydrotreated feedstock from said effluent gas, thereby leaving a recycle gas containing unreacted hydrogen and hydrogenated heteroatoms;
a removal device for removing said hydrogenated heteroatoms from said recycle gas; and
a recycle gas compressor for compressing said recycle gas and feeding said compressed recycle gas to said flash device;
said apparatus being operable to achieve a ratio of said recycle gas and hydrogen to said hydrocarbon feedstock effective to ensure complete vaporization of said feedstock in said flash device.

12. The apparatus of claim 11, wherein said catalyst bed contains a structured catalyst body.
